(19) United States
(12) Patent Application Publication
(10) Pub. No.: US 2026/0304576 A1
(43) Pub. Date: Oct. 1, 2026

(54) DRIVING ASSISTANCE APPARATUS AND DRIVING ASSISTANCE METHOD

(71) Applicant: Mitsubishi Electric Mobility Corporation, Tokyo (JP)

(72) Inventors: Mitsuo SHIMOTANI, Tokyo (JP); Satoru INOUE, Tokyo (JP); Satoshi KAWAMURA, Tokyo (JP); Yoshitaka ONISHI, Tokyo (JP); Hiroki NAKAMOTO, Tokyo (JP)

(73) Assignee: Mitsubishi Electric Mobility Corporation, Tokyo (JP)

(21) Appl. No.: 19/475,983

(22) PCT Filed: Jun. 8, 2023
(86) PCT No.: PCT/JP2023/021342

§ 371 Date: Oct. 16, 2025

(51) Int. Cl. H05B 47/11; B60Q 1/18

(52) U.S. Cl. CPC H05B 47/11; B60Q 1/18

(57) ABSTRACT

A driving assistance apparatus includes: a road shape information acquisition unit to acquire information on a shape of a road on which a host vehicle is traveling; a side wall information acquisition unit to acquire information on whether the road has a side wall; a brightness judgement unit to judge whether brightness in the surroundings is brightness requiring assistive irradiation being irradiation with light encouraging a driver to recognize the shape of the road; an assistive irradiation determination unit to determine whether assistive irradiation is performed; and an assistive irradiation control unit to control a lighting apparatus to perform assistive irradiation. The assistive irradiation determination unit determines that assistive irradiation is performed when the road has the side wall, the road is curved horizontally or vertically, and it is judged that brightness in the surroundings is brightness requiring assistive irradiation.

### TECHNICAL FIELD

The present disclosure relates to a driving assistance apparatus to assist driving of a vehicle.

### BACKGROUND ART

Patent Document 1 below discloses a driving assistance apparatus to adjust an optical axis direction of a headlamp of a vehicle according to a shape of a road to improve visibility of a road surface of a curved road.

### PRIOR ART DOCUMENTS

### Patent Document

Patent Document 1: Japanese Patent Application Laid-Open No. 2005-59839

### SUMMARY

### Problem to be Solved by the Invention

For example, when a side wall and a road surface of a road have close color tones (e.g., hue, chroma, and lightness), or markings and the road surface of the road have close color tones, it is sometimes difficult for a driver to recognize a shape of the road through illumination of the road surface by a headlamp. Technology to improve a degree of recognition of the shape of the road by the driver is thus desired.

The present disclosure has been conceived to solve a problem as described above, and it is an object of the present disclosure to provide a driving assistance apparatus enabling improvement in degree of recognition of a shape of a road by a driver.

### Means to Solve the Problem

A driving assistance apparatus according to the present disclosure includes: a road shape information acquisition unit to acquire information on a shape of a road on which a host vehicle is traveling; a side wall information acquisition unit to acquire information on whether the road has a side wall; a brightness judgement unit to judge whether brightness around the host vehicle is brightness requiring assistive irradiation, the assistive irradiation being irradiation with light encouraging a driver of the host vehicle to recognize the shape of the road; an assistive irradiation determination unit to determine whether the assistive irradiation is performed based on the presence or absence of the side wall of the road, the shape of the road, and a result of judgment on the brightness around the host vehicle; and an assistive irradiation control unit to control a lighting apparatus of the host vehicle to perform the assistive irradiation when it is determined that the assistive irradiation is performed, wherein the assistive irradiation determination unit determines that the assistive irradiation is performed when the road has the side wall, the road is curved horizontally or vertically, and it is judged that the brightness around the host vehicle is the brightness requiring the assistive irradiation, and the assistive irradiation control unit irradiates the side wall of the road with at least part of the light to perform the assistive irradiation.

### Effects of the Invention

According to the present disclosure, a degree of recognition of the shape of the road by the driver can be improved.

These and other objects, features, aspects and advantages of the present disclosure will become more apparent from the following detailed description when taken in conjunction with the accompanying drawings.

### BRIEF DESCRIPTION OF DRAWINGS

FIG. 1 is a diagram showing a configuration of a driving assistance apparatus according to Embodiment 1.

FIG. 2 is a diagram illustrating an example of assistive irradiation.

FIG. 3 is a diagram illustrating an example of assistive irradiation.

FIG. 4 is a diagram illustrating an example of assistive irradiation,

FIG. 5 is a diagram illustrating an example of assistive irradiation.

FIG. 6 is a flowchart showing operation of the driving assistance apparatus according to Embodiment 1.

FIG. 7 is a diagram illustrating an example of assistive irradiation.

FIG. 8 is a diagram illustrating an example of assistive irradiation.

FIG. 9 is a diagram illustrating an example of assistive irradiation.

FIG. 10 is a diagram illustrating an example of assistive irradiation.

FIG. 11 is a diagram illustrating an example of assistive irradiation.

FIG. 12 is a diagram illustrating an example of assistive irradiation.

FIG. 13 is a diagram illustrating an example of assistive irradiation.

FIG. 14 is a diagram illustrating an example of assistive irradiation.

FIG. 15 is a diagram illustrating an example of assistive irradiation.

FIG. 16 is a diagram showing a configuration of a vehicle system according to Embodiment 2.

FIG. 17 is a flowchart showing operation of a driving assistance apparatus according to Embodiment 2.

FIG. 18 is a flowchart showing operation of a driving assistance apparatus according to Embodiment 3.

FIG. 19 is a diagram showing an example of a hardware configuration of a driving assistance apparatus.

FIG. 20 is a diagram showing an example of the hardware configuration of the driving assistance apparatus.

### DESCRIPTION OF EMBODIMENTS

### Embodiment 1

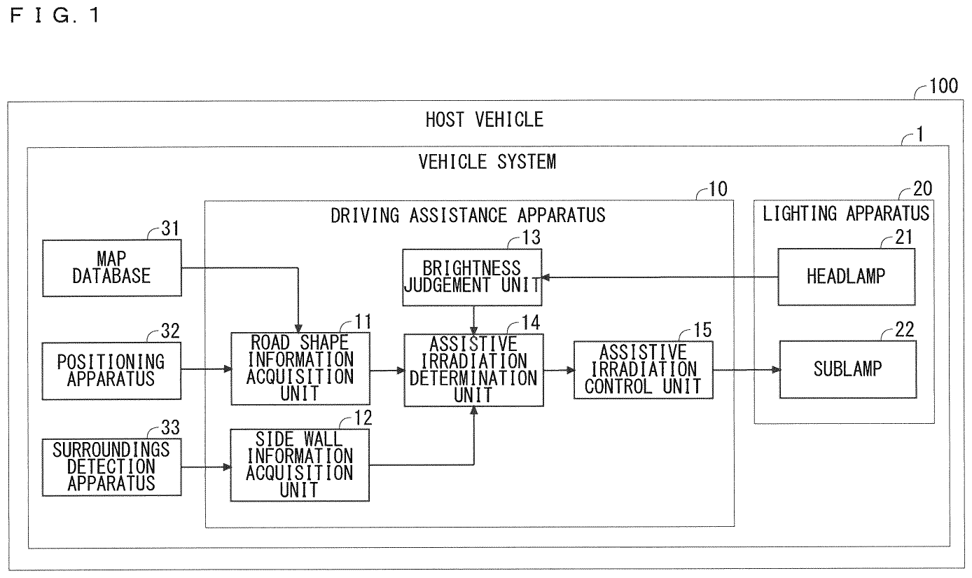

FIG. 1 is a diagram showing a configuration of a driving assistance apparatus 10 according to Embodiment 1. Assume that the driving assistance apparatus 10 has been incorporated in a vehicle system 1 in the present embodiment. A vehicle 100 equipped with the vehicle system 1 in which the driving assistance apparatus 10 has been incorporated is hereinafter referred to as a “host vehicle”.

The driving assistance apparatus 10 is connected to a lighting apparatus 20, a map database 31, a positioning apparatus 32, and a surroundings detection apparatus 33 of the vehicle system 1.

The lighting apparatus 20 includes a headlamp 21 and a sublamp 22. The headlamp 21 is a general lamp to perform irradiation with light to ensure visibility ahead of the host vehicle 100 during travel at night or through a tunnel. The sublamp 22 is a lamp to perform assistive irradiation that is irradiation with light to assist driving of a driver of the host vehicle 100 and can control an irradiation direction of light and an irradiation mode. If the headlamp 21 can control the irradiation direction of light and the irradiation mode, the headlamp 21 may be used for assistive irradiation.

The map database 31 is a database to store map data. The map data stored in the map database 31 is at least required to include information on a position and a shape of a road but may also include information on the presence or absence of a side wall of the road.

The positioning apparatus 32 is an apparatus to measure a position of the host vehicle 100 based on a positioning signal received from a global navigation satellite system (GNSS) satellite.

The surroundings detection apparatus 33 is an apparatus to detect information on a surrounding environment of the host vehicle 100 and includes light detection and ranging (LiDAR), a millimeter wave radar, an in-vehicle camera, and the like, for example.

The driving assistance apparatus 10 controls the lighting apparatus 20 based on information acquired from the lighting apparatus 20, the map database 31, the positioning apparatus 32, and the surroundings detection apparatus 33 to perform assistive irradiation. Assistive irradiation in the present embodiment is irradiation with light encouraging the driver of the host vehicle 100 to recognize the shape of the road and is performed by irradiating the side wall of the road with at least part of the light.

As shown in FIG. 1, the driving assistance apparatus 10 includes a road shape information acquisition unit 11, a side wall information acquisition unit 12, a brightness judgement unit 13, an assistive irradiation determination unit 14, and an assistive irradiation control unit 15.

The road shape information acquisition unit 11 checks the position of the host vehicle 100 measured by the positioning apparatus 32 against the map data in the map database 31 to specify a road on which the host vehicle 100 is traveling and reads information on a shape (e.g., a radius of curvature and a gradient) of the road from the map database 31 to acquire the information on the shape of the road on which the host vehicle 100 is traveling. The road shape information acquisition unit 11 at least acquires information on a shape of a road ahead of the host vehicle 100. A means by which the road shape information acquisition unit 11 acquires the information on the shape of the road is not limited to the map database 31. For example, the road shape information acquisition unit 11 may acquire the information on the shape of the road ahead of the host vehicle 100 detected by the surroundings detection apparatus 33.

The side wall information acquisition unit 12 acquires the information on the surrounding environment (hereinafter referred to as “surroundings information”) of the host vehicle 100 from the surroundings detection apparatus 33 and acquires information on whether the road on which the host vehicle 100 is traveling has the side wall from the surroundings information. The side wall information acquisition unit 12 at least acquires the information on the presence or absence of the side wall of the road ahead of the host vehicle 100. A means by which the side wall information acquisition unit 12 acquires the information on the presence or absence of the side wall is not limited to the surroundings detection apparatus 33. For example, when the map data in the map database 31 includes information on the side wall of the road, the side wall information acquisition unit 12 may acquire the information on the presence or absence of the side wall of the road on which the host vehicle 100 is traveling from the map database 31.

The brightness judgement unit 13 judges whether brightness around the host vehicle 100 is brightness requiring assistive irradiation (i.e., irradiation with light encouraging the driver of the host vehicle 100 to recognize the shape of the road). Assume that the brightness judgement unit 13 judges brightness based on usage of the headlamp 21 in the present embodiment. Specifically, it is determined that it is dark around the host vehicle 100 and brightness around the host vehicle 100 is brightness requiring assistive irradiation when the headlamp 21 is on, and it is determined that it is bright around the host vehicle 100 and brightness around the host vehicle 100 is brightness not requiring assistive irradiation when the headlamp 21 is off. A method of determining brightness is not limited to this method. For example, the brightness judgement unit 13 may judge whether brightness around the host vehicle 100 is brightness requiring assistive irradiation based on usage of a small lamp or a fog lamp, brightness around the host vehicle 100 actually measured by an illuminometer, lightness of an image around the host vehicle 100 captured by the in-vehicle camera, and the like.

The assistive irradiation determination unit 14 determines whether assistive irradiation is performed based on the presence or absence of the side wall of the road on which the host vehicle 100 is traveling, the shape of the road, and a result of judgment on brightness around the host vehicle 100. Specifically, the assistive irradiation determination unit 14 determines that assistive irradiation is performed when the road on which the host vehicle 100 is traveling has the side wall, the road is curved horizontally or vertically, and it is judged that brightness around the host vehicle 100 is brightness requiring assistive irradiation. A method of judging whether the road is curved may be any method. An example of a method of judging whether the road is curved horizontally includes a method of judging whether a radius of curvature of the road is less than 100 m. An example of a method of judging whether the road is curved vertically includes a method of judging whether a change in gradient of the road is 1% or more.

Judgement on whether the road is curved may take into account both a horizontal curve and a vertical curve. It is judged that a road having a radius of curvature of 100 m or more and a road having a change in gradient of 0.5% or more and less than 1% are not curved in the above-mentioned judgement method. However, when both the horizontal curve and the vertical curve are taken into account, and the road has a radius of curvature of 100 m or more and 150 m or less and has a change in gradient of 0.5% or more and less than 1%, for example, it may be determined that the road is curved. That is to say, whether the road is curved may be judged using evaluation functions to which the radius of curvature and the change in gradient of the road have been weighted.

Judgement on whether the road is curved may take into account a travel speed of the host vehicle 100. An influence of the curve of the road increases with increasing travel speed of the host vehicle 100. Thus, a threshold of the radius of curvature to judge the horizontal curve of the road may be increased, or a threshold of the change in gradient to judge the vertical curve of the road may be decreased with increasing travel speed of the host vehicle 100 to facilitate judgment that the road is curved.

The assistive irradiation control unit 15 controls the lighting apparatus 20 to perform assistive irradiation when the assistive irradiation determination unit 14 determines that assistive irradiation is performed. While the assistive irradiation control unit 15 controls the sublamp 22 to perform assistive irradiation in the present embodiment, the headlamp 21 may be used for assistive irradiation as described above.

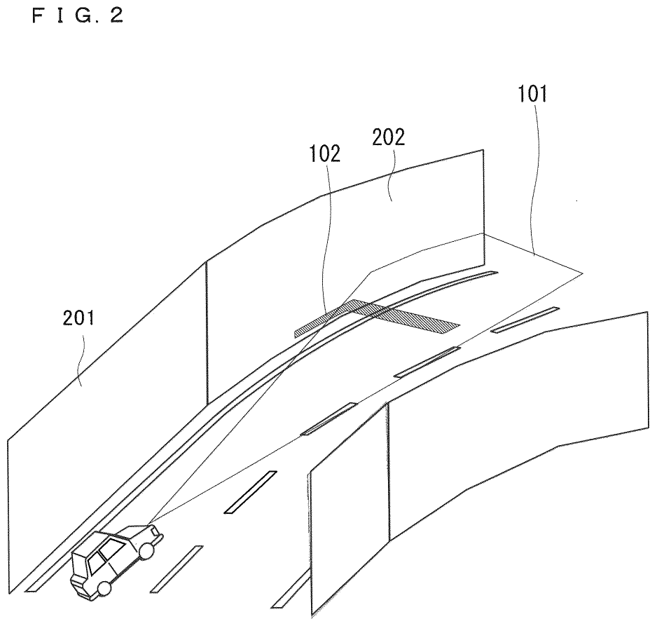

Several specific examples of assistive irradiation will be described below. Assume herein a situation in which the road on which the host vehicle 100 is traveling changes from a straight road to a curved road (horizontally curved road), i.e., a situation in which the host vehicle 100 enters the curved road from the straight road as illustrated in FIG. 2. The straight road has a straight side wall 201 as a linear side wall, and the curved road has a curved side wall 202 as a curvilinear side wall along the curved road. Furthermore, the headlamp 21 is on (headlamp light 101 emitted by the headlamp 21 is illustrated in FIG. 2), and the brightness judgement unit 13 judges that brightness around the host vehicle 100 is brightness requiring assistive irradiation. As described above, the situation in FIG. 2 is a situation in which the road on which the host vehicle 100 is traveling has side walls (the straight side wall 201 and the curved side wall 202), the road is curved, and brightness around the host vehicle 100 is brightness requiring assistive irradiation. The assistive irradiation determination unit 14 thus determines that assistive irradiation is performed, and the assistive irradiation control unit 15 performs assistive irradiation.

FIG. 2 illustrates, as an example of assistive irradiation, an example in which a road surface ahead of the host vehicle 100 is irradiated with one bar-like (a horizontal rod-like) irradiation pattern 102 extending perpendicularly to a direction of travel of the host vehicle 100. The curved side wall 202 is irradiated with a portion of the irradiation pattern 102. When viewed from the host vehicle 100, a direction of extension of the irradiation pattern 102 on the road surface is horizontal to the road surface, but a direction of extension of the irradiation pattern 102 on the curved side wall 202 is inclined to the road surface, so that the driver of the host vehicle 100 can recognize the presence of the curved side wall 202 from a position of the irradiation pattern 102 viewed to be inclined. An irradiation position with the irradiation pattern 102 may be only a certain distance (e.g., 30 m) ahead of the host vehicle 100. When the irradiation position with the irradiation pattern 102 is the position at the certain distance from the host vehicle 100, control of the irradiation position by the driving assistance apparatus 105 can be simplified.

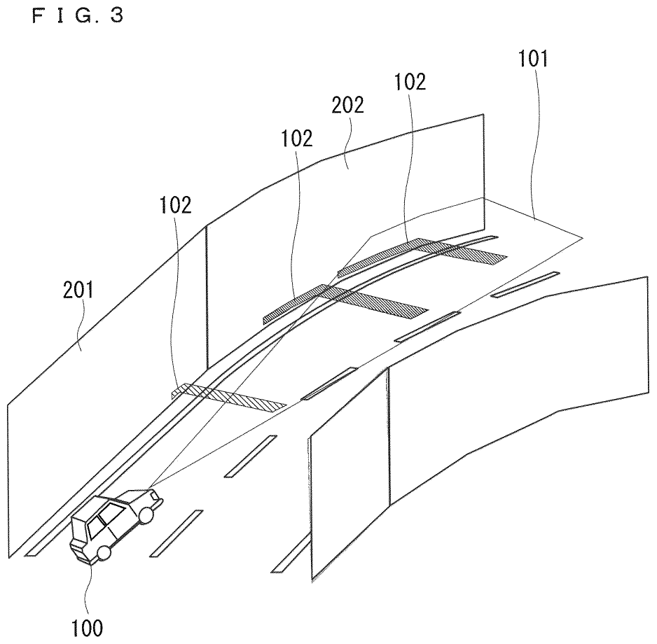

The number of bar-like irradiation patterns 102 may be two or more. In this case, as illustrated in FIG. 3, the irradiation mode may vary between the irradiation pattern 102 with which the straight side wall 201 is irradiated and the irradiation pattern 102 with which the curved side wall 202 is irradiated. In this case, the irradiation pattern 102 with which the curved side wall 202 is irradiated is preferably more prominent (preferably has high visibility) than the irradiation pattern 102 with which the straight side wall 201 is irradiated. Specifically, considered are a case where the irradiation pattern 102 with which the curved side wall 202 is irradiated is wider than the irradiation pattern 102 with which the straight side wall 201 is irradiated, a case where spacing between irradiation patterns 102 with which the curved side wall 202 is irradiated is smaller than spacing between irradiation patterns 102 with which the straight side wall 201 is irradiated, and a case where a color tone of the irradiation pattern 102 with which the curved side wall 202 is irradiated is lighter than a color tone of the irradiation pattern 102 with which the straight side wall 201 is irradiated.

The irradiation mode may vary between a portion of the bar-like irradiation pattern 102 with which the road surface is irradiated and a portion of the bar-like irradiation pattern 102 with which the side wall is irradiated. For example, a color tone, a thickness, and the like may vary between the portion of the irradiation pattern 102 with which the road surface is irradiated and the portion of the irradiation pattern 102 with which the side wall is irradiated. This makes it easier to distinguish between the portion of the irradiation pattern 102 with which the road surface is irradiated and the portion of the irradiation pattern 102 with which the side wall is irradiated, and the driver of the host vehicle 100 is more likely to recognize the presence of the curved side wall 202.

The bar-like irradiation pattern 102 may have a width barely reaching the side wall when the road is straight. In this case, the irradiation pattern 102 reaches the curved side wall 202 but does not reach the straight side wall 201, The driver can distinguish between the straight side wall 201 and the curved side wall 202 by the presence or absence of the irradiation pattern 102 viewed to be inclined. The irradiation pattern 102 not reaching the straight side wall 201, however, is difficult to indicate a situation in which the straight road is curved vertically, so that it can be said that the irradiation pattern 102 not reaching the straight side wall 201 is particularly for a case where it indicates the horizontal curve of the road.

The irradiation pattern 102 may not be a solid line (continuous linear) pattern but may be a dashed line or dotted line pattern. For example, the bar-like irradiation pattern 102 may be a pattern with which the side wall and a portion near the side wall are irradiated and a central portion of the road is not irradiated.

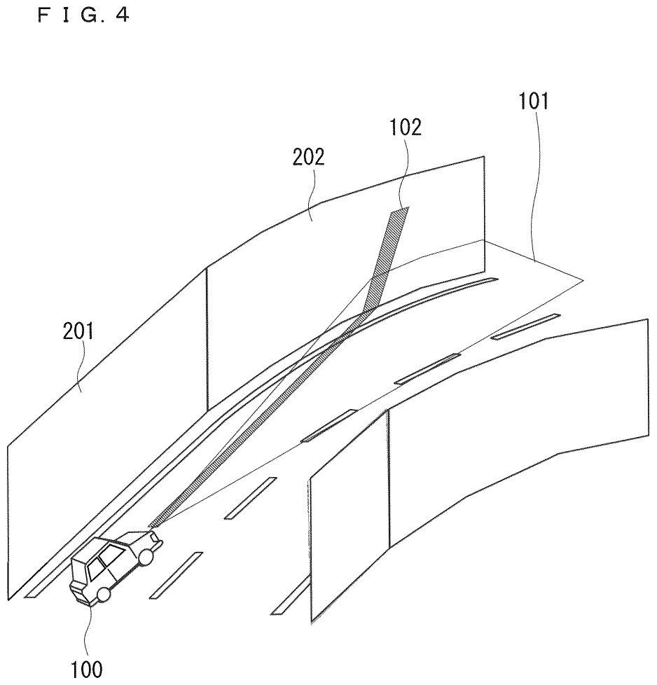

The irradiation pattern 102 may be a linear (vertical rod-like) pattern extending along the direction of travel of the host vehicle 100. FIG. 4 illustrates an example of assistive irradiation in which the road surface ahead of the host vehicle 100 is irradiated with one linear irradiation pattern 102 extending along the direction of travel of the host vehicle 100.

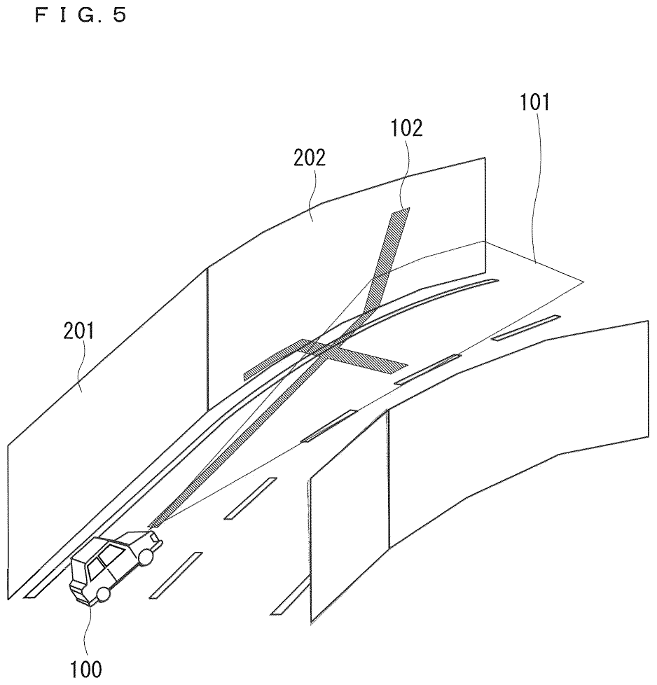

The irradiation pattern 102 may be a pattern as a combination of a bar-like pattern and a linear pattern. FIG. 5 illustrates an example of assistive irradiation in which the road surface ahead of the host vehicle 100 is irradiated with a cross-shaped irradiation pattern 102 as a combination of one bar-like pattern and one linear pattern. The irradiation pattern 102 may be a pattern as a combination of one linear pattern and a plurality of bar-like patterns intersecting the one linear pattern. The irradiation pattern 102 as the combination of the bar-like pattern and the linear pattern is effective on a helical road having a long curve, such as an interchange on a highway.

As described above, according to the driving assistance apparatus 10 according to Embodiment 1, irradiation of the side wall of the road with assistive irradiation light can encourage the driver to recognize the shape of the curved road. A degree of recognition of the shape of the road by the driver can thereby be improved. As a result, risk of a collision of the host vehicle 100 with the side wall is reduced to contribute to safe driving.

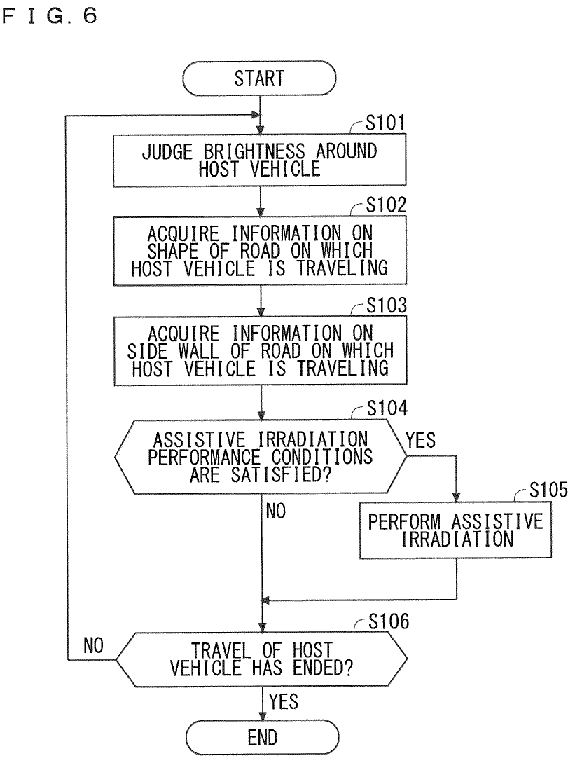

FIG. 6 is a flowchart showing operation of the driving assistance apparatus 10 according to Embodiment 1. Operation of the driving assistance apparatus 10 will be described below with reference to the flowchart of FIG. 6.

When the driving assistance apparatus 10 is activated, and the host vehicle 100 starts traveling, the brightness judgement unit 13 judges whether brightness around the host vehicle 100 is brightness requiring assistive irradiation based on the usage of the headlamp 21 (step S101).

The road shape information acquisition unit 11 checks the position of the host vehicle 100 measured by the positioning apparatus 32 against the map data in the map database 31 to specify the road on which the host vehicle 100 is traveling and acquires the information on the shape of the road on which the host vehicle 100 is traveling from the map database 31 (step S102).

The side wall information acquisition unit 12 acquires the information on whether the road on which the host vehicle 100 is traveling has the side wall from the surroundings detection apparatus 33 (step S103).

The assistive irradiation determination unit 14 determines whether conditions to perform assistive irradiation (assistive irradiation performance conditions) are satisfied based on the pieces of information acquired in steps S101 to S103 (step S104). Specifically, the assistive irradiation determination unit 14 determines that assistive irradiation is performed when the road on which the host vehicle 100 is traveling has the side wall, the road is curved horizontally or vertically, and it is judged that brightness around the host vehicle 100 is brightness requiring assistive irradiation.

When the assistive irradiation performance conditions are satisfied (YES in step S104), the assistive irradiation control unit 15 controls the sublamp 22 to perform assistive irradiation (step S105). When the assistive irradiation performance conditions are not satisfied (NO in step S104), assistive irradiation is not performed.

The driving assistance apparatus 10 then checks whether travel of the host vehicle 100 has ended (step S106), Processing returns to step S101 when travel of the host vehicle 100 is continued (NO in step S106), and operation of the driving assistance apparatus 10 ends when travel of the host vehicle 100 has ended (YES in step S106).

### Modifications

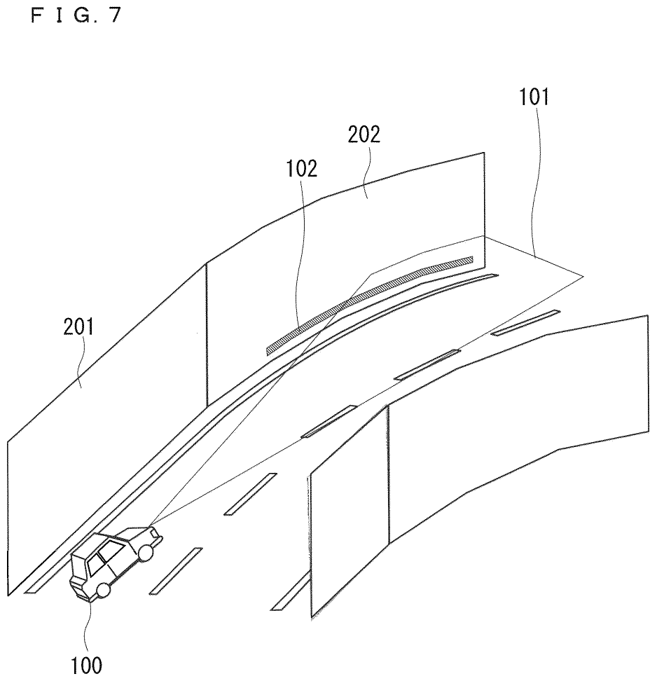

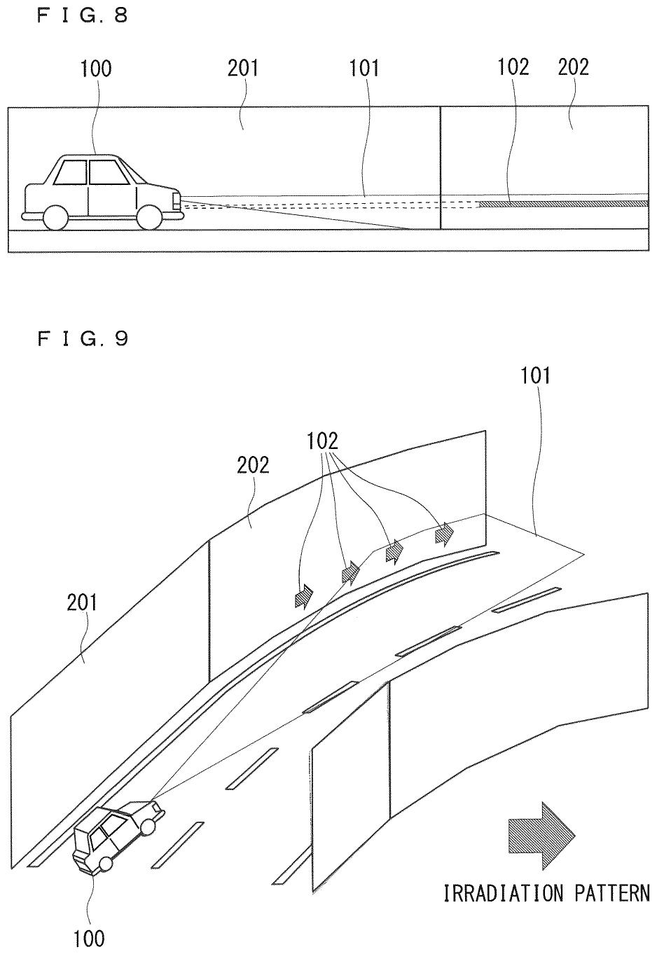

Assistive irradiation may be irradiation in a horizontal direction (a certain height direction) with fan-shaped light extending horizontally but not extending vertically. In this case, as illustrated in FIGS. 7 and 8, the road surface is not irradiated with the irradiation pattern 102, and the curved side wall 202 is irradiated with a linear irradiation pattern 102 extending horizontally. Compared with a case where the road surface is irradiated with the irradiation pattern 102 as illustrated in FIGS. 2 to 5, the irradiation pattern 102 being an obstacle for the driver of the host vehicle 100 can be suppressed. It is, however, to be noted that an effect of encouraging the driver to recognize a boundary between the road surface and the side wall of the road is reduced when the road surface is not irradiated with the irradiation pattern 102.

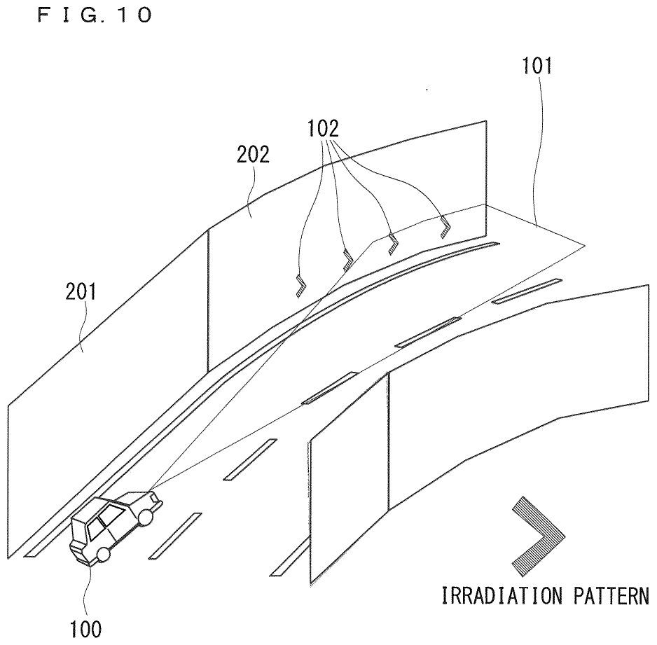

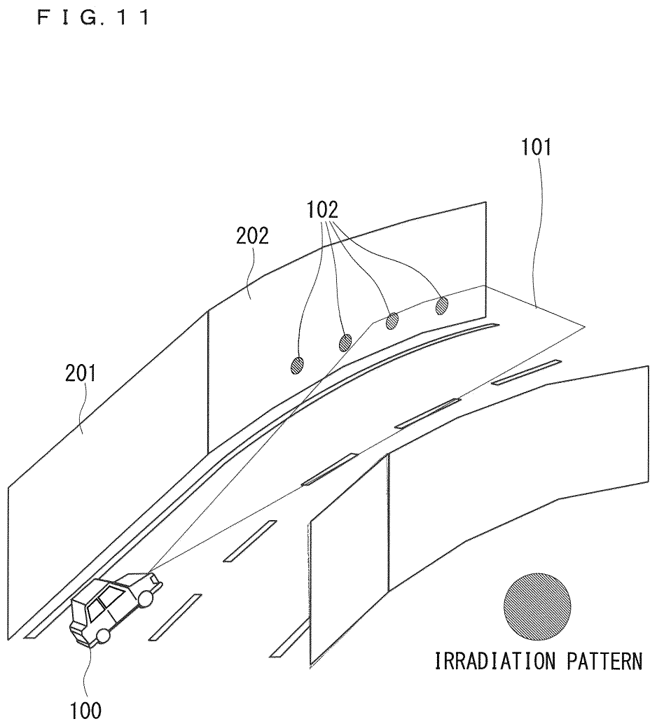

As illustrated in FIGS. 9 to 11, assistive irradiation may be performed by irradiating the side wall with a plurality of irradiation patterns 102. FIG. 9 illustrates an example in which the irradiation patterns 102 are arrow-shaped, FIG. 10 illustrates an example in which the irradiation patterns 102 are L-shaped, and FIG. 11 illustrates an example in which the irradiation patterns 102 are disc-shaped. These irradiation patterns 102 simulate road structures (e.g., reflectors and LED lamps arranged on the side wall) encouraging recognition of the shape of the road, are compatible with the side wall, and can suppress a feeling of strangeness that the irradiation patterns 102 bring to the driver of the host vehicle 100.

An animation effect of changing a mode, such as flashing, a change in color, and a change in position, over time may be imparted to the irradiation pattern 102. The irradiation pattern 102 may be one dot pattern. The animation effect is preferably imparted to the irradiation pattern 102 when the road has a low curvature.

The mode of the irradiation pattern 102 may be changed according to the shape of the road on which the host vehicle 100 is traveling. For example, the irradiation pattern 102 may be more prominent when the road has a higher curvature. Specifically, bar-like irradiation patterns 102 may each be wider, may be larger in number, or may have higher density when the road has a higher curvature.

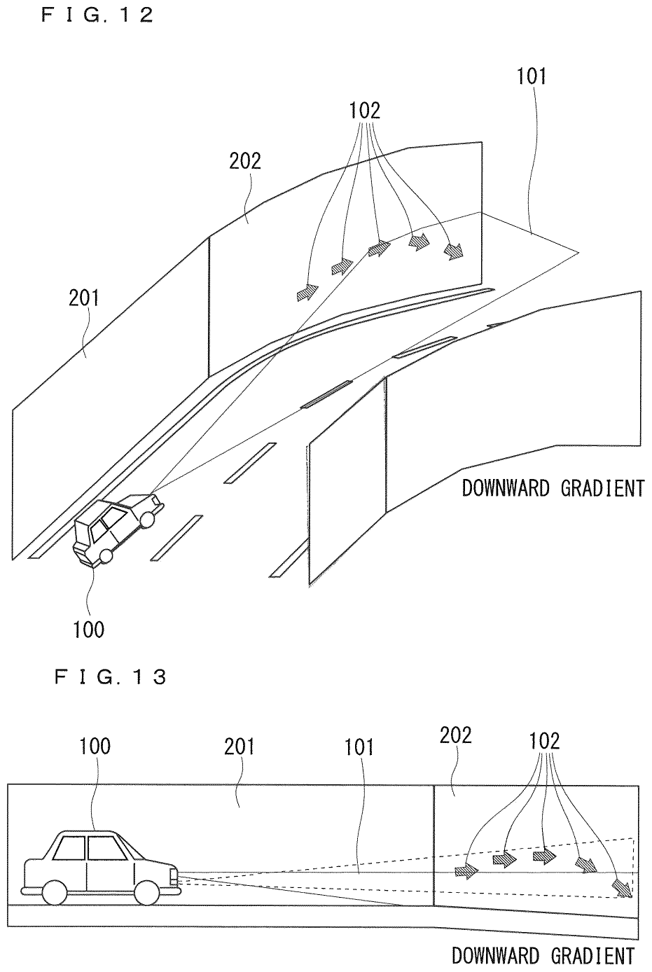

FIGS. 12 to 15 each illustrate an example of assistive irradiation suitable to indicate that the road is curved vertically. For example, when the host vehicle 100 enters a descent, the side wall may be irradiated with a plurality of arrow-shaped irradiation patterns 102 arranged along a convex upward curve as illustrated in FIGS. 12 and 13. In contrast, when the host vehicle 100 enters an ascent, the side wall may be irradiated with a plurality of arrow-shaped irradiation patterns 102 arranged along a convex upward curve.

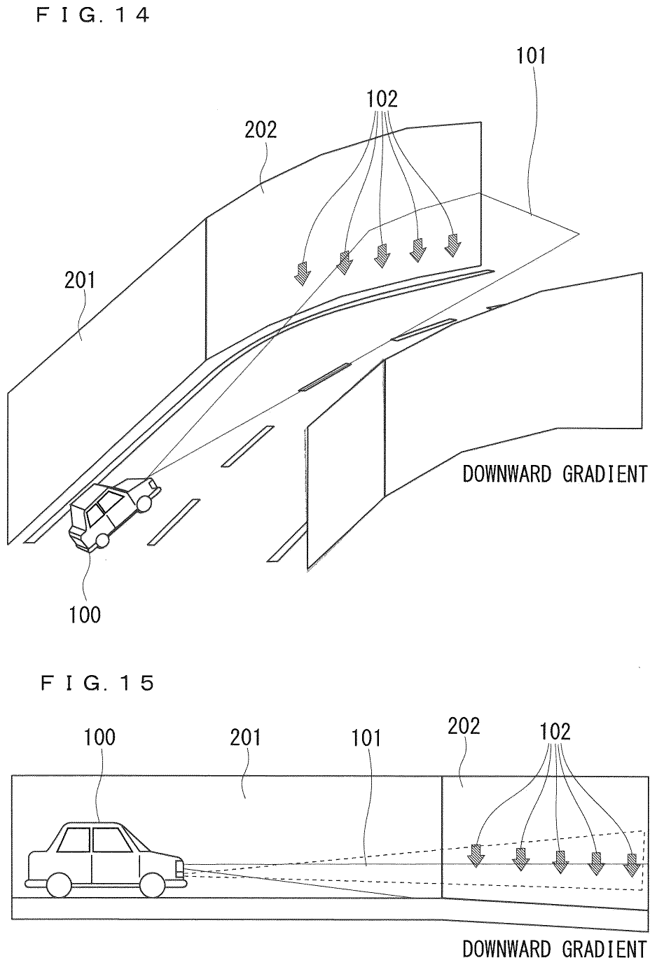

When the host vehicle 100 enters a descent, the side wall may be irradiated with a plurality of down-pointing arrow-shaped irradiation patterns 102 as illustrated in FIGS. 14 and 15. In contrast, when the host vehicle 100 enters an ascent, the side wall may be irradiated with a plurality of up-pointing arrow-shaped irradiation patterns 102. A portion at a certain height from the road surface may be irradiated with the plurality of arrow-shaped irradiation patterns 102.

The irradiation position and the mode of the irradiation pattern 102 may be changed according to the travel speed of the host vehicle 100. For example, the irradiation position of the irradiation pattern 102 may be controlled so that a portion that the host vehicle 100 reaches in three seconds may be irradiated with the irradiation pattern 102. The mode of the irradiation pattern 102 may be controlled so that the irradiation pattern 102 is more prominent when the host vehicle 100 travels at a higher speed.

The irradiation position and the mode of the irradiation pattern 102 may be changed in view of both the shape of the road on which the host vehicle 100 is traveling and the travel speed of the host vehicle 100.

### Embodiment 2

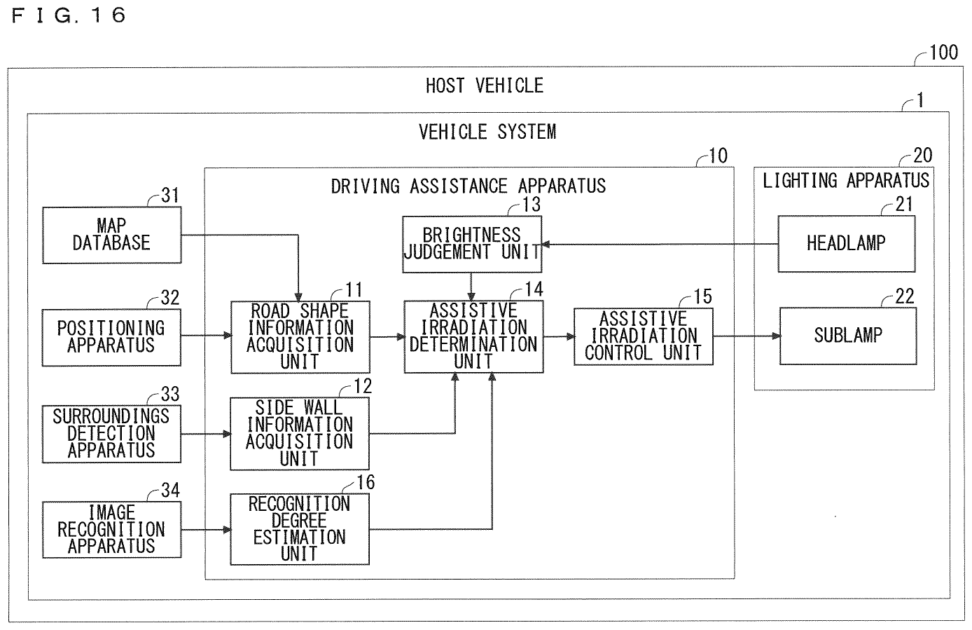

FIG. 16 is a diagram showing a configuration of the vehicle system 1 according to Embodiment 2. The configuration of the vehicle system 1 in FIG. 16 is the configuration in FIG. 1 in which an image recognition apparatus 34 has been connected to the driving assistance apparatus 10 and a recognition degree estimation unit 16 has been added in the driving assistance apparatus 10.

The image recognition apparatus 34 analyzes an image around the driving assistance apparatus 10 captured by the in-vehicle camera (not shown) of the host vehicle 100 and recognizes color tones (e.g., hue, chroma, and lightness) of the road on which the host vehicle 100 is traveling and the side wall.

The recognition degree estimation unit 16 acquires information on the color tones of the side wall and the road surface of the road on which the host vehicle 100 is traveling from the image recognition apparatus 34 and estimates a degree of recognition of the shape of the road by the driver based on a difference in color tone between the side wall and the road surface. It is generally difficult for the driver to recognize the shape of the road when the difference in color tone between the side wall and the road surface is small. The recognition degree estimation unit 16 thus estimates that the degree of recognition of the shape of the road by the driver is low when the difference in color tone between the side wall and the road surface is small and estimates that the degree of recognition of the shape of the road by the driver is high when the difference in color tone between the side wall and the road surface is large.

In Embodiment 2, the assistive irradiation control unit 15 determines that assistive irradiation is not performed when the degree of recognition of the shape of the road by the driver estimated by the recognition degree estimation unit 16 is a predetermined threshold or more.

The recognition degree estimation unit 16 is only required to calculate an average value of the difference in color tone between the road surface and the side wall in a predetermined range ahead of the host vehicle 100 as the difference in color tone between the side wall and the road surface. In the present embodiment, the recognition degree estimation unit 16 calculates the average value of the difference in color tone between the road surface and the side wall in a range through which the host vehicle 100 passes from two seconds later to three seconds later as the difference in color tone between the side wall and the road surface. In this case, when an equation L=L3−L2 holds true where L2 is a distance that the host vehicle 100 reaches in two seconds, L3 is a distance that the host vehicle 100 reaches in three seconds, a difference D in color tone between the road surface and the side wall is calculated by the following equation:

$$D = \int \vert Cdri ( r ) - Cdwi ( r ) \vert / L ( r = L 2 to L 3 ) \qquad ( 1 )$$

In this equation, r is a distance from the host vehicle 100, Cdri(r) is the color tone of the road surface at the distance r, and Cdwi(r) is the color tone of the side wall at the distance r.

A range in which the average value of the difference in color tone is calculated may be wider than the range from two seconds later to three seconds later. Alternatively, the difference in color tone may be obtained in a range wider than the range from two seconds later to three seconds later, and a weighted average in which the difference in color tone in the range from two seconds later to three seconds later is given more weight may be calculated as the difference in color tone between the side wall and the road surface.

A parameter of a color tone used for calculation of the difference in color tone may be any one of or two or more of hue, chroma, and lightness or may be another parameter. For example, the difference in color tone may be calculated from a value of a contrast between the road surface and the side wall in the image around the host vehicle 100.

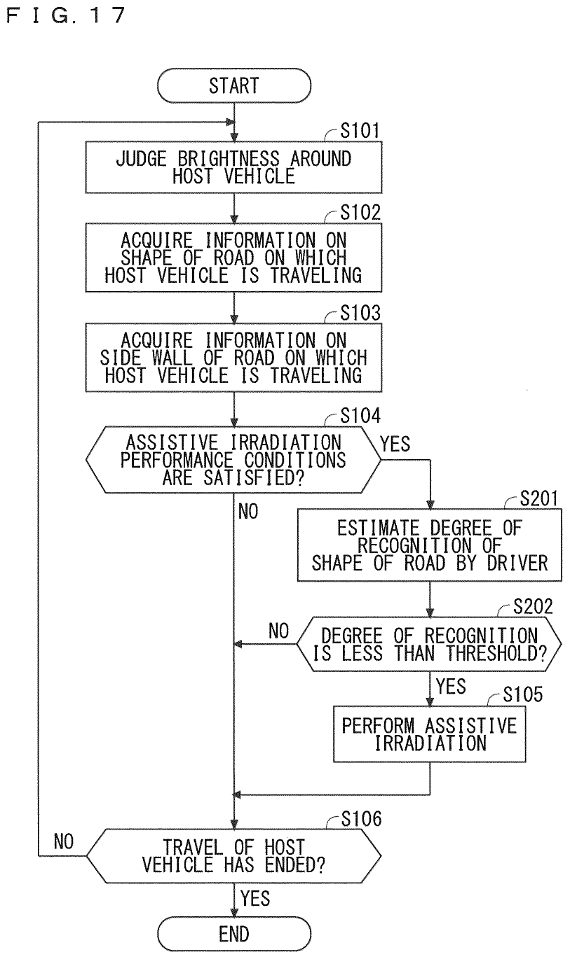

FIG. 17 is a flowchart showing operation of a driving assistance apparatus 10 according to Embodiment 2. The flowchart in FIG. 17 is the flowchart in FIG. 6 in which steps S201 and S202 have been added between steps S104 and S105.

Step S201 is performed when it is determined that the conditions to perform assistive irradiation (assistive irradiation performance conditions) are satisfied in step S104 (YES in step S104). In step S201, the recognition degree estimation unit 16 calculates the difference in color tone between the side wall and the road surface from the information on the color tones of the side wall and the road surface of the road on which the host vehicle 100 is traveling acquired from the image recognition apparatus 34 and estimates the degree of recognition of the shape of the road by the driver.

Step S202 is performed after step S201. In step S202, the assistive irradiation determination unit 14 checks whether the degree of recognition estimated in step S201 is less than the predetermined threshold. When the degree of recognition is less than the threshold (YES in step S202), the assistive irradiation determination unit 14 determines that assistive irradiation is performed, and assistive irradiation is performed in step S105. When the degree of recognition is the threshold or more (NO in step S202), however, the assistive irradiation determination unit 14 determines that assistive irradiation is not required to be performed, and processing proceeds to step S106 without performing assistive irradiation.

According to the driving assistance apparatus 10 according to Embodiment 2, unnecessary assistive irradiation is not performed when the degree of recognition of the shape of the road by the driver is high, so that assistive irradiation being an obstacle for the driver can be suppressed to contribute to reduction in power consumption.

### Modifications

While an example in which the recognition degree estimation unit 16 estimates the degree of recognition of the shape of the road by the driver based on the difference in color tone between the side wall and the road surface of the road has been shown in Embodiment 2, a method of estimating the degree of recognition of the shape of the road is not limited to this method.

Markings of the road are one means to recognize the shape of the road for the driver. The recognition degree estimation unit 16 may thus estimate the degree of recognition of the shape of the road by the driver based on a difference in color tone between the road and the markings. The difference in color tone between the road and the markings can be calculated by analyzing the image around the host vehicle 100 captured by the in-vehicle camera, for example.

It becomes difficult for the driver to recognize the shape of the road when it grows dark in the surroundings. The recognition degree estimation unit 16 may thus estimate the degree of recognition of the shape of the road by the driver based on brightness around the host vehicle 100. Brightness in the surroundings may be calculated by analyzing the image around the host vehicle 100 captured by the in-vehicle camera or may actually be measured by the illuminometer, for example.

When the road structures (e.g., the reflectors and the LED lamps arranged on the side wall) encouraging recognition of the shape of the road are arranged, the driver can easily recognize the shape of the road. The recognition degree estimation unit 16 may thus estimate the degree of recognition of the shape of the road by the driver based on the presence or absence of the road structures. The presence or absence of the road structures can be determined by analyzing the image around the host vehicle 100 captured by the in-vehicle camera, for example.

The recognition degree estimation unit 16 may estimate the degree of recognition of the shape of the road by the driver from a visual ability of the driver. The recognition degree estimation unit 16 may estimate the visual ability of the driver by any method. For example, when the recognition degree estimation unit 16 monitors an operational status of the host vehicle 100 by the driver using a driver monitoring system (DMS), and an operating error and sudden driving operation (e.g., swerving and hard braking) occur with high frequency, it may be estimated that the visual ability of the driver is low. When the recognition degree estimation unit 16 detects a psychological state or a physiological state of the driver using the DMS, and the driver has a high degree of fatigue, low alertness, or wandering eyes with unfixed vision, it may also be estimated that a substantial visual ability is reduced. The driver may be able to input information indicating his/her qualification ability (e.g., eyesight and with or without a history of a cataract) into the recognition degree estimation unit 16 in advance.

The recognition degree estimation unit 16 may combine two or more of the above-mentioned methods to estimate the degree of recognition of the shape of the road by the driver.

### Embodiment 3

A configuration of a vehicle system 1 according to Embodiment 3 is similar to that according to Embodiment 2 (FIG. 16). In the driving assistance apparatus 10 according to Embodiment 3, the assistive irradiation control unit 15 changes the mode of assistive irradiation according to the degree of recognition of the shape of the road by the driver estimated by the recognition degree estimation unit 16. Specifically, the assistive irradiation control unit 15 performs assistive irradiation in a more prominent mode (high visibility mode) when the degree of recognition of the shape of the road by the driver is lower.

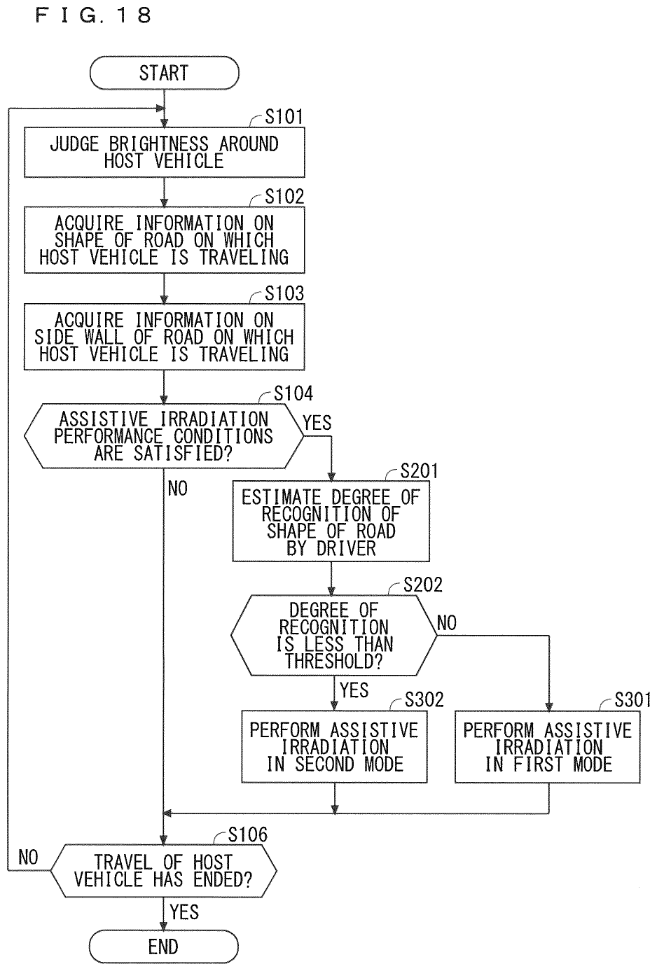

FIG. 18 is a flowchart showing operation of a driving assistance apparatus 10 according to Embodiment 3. The flowchart in FIG. 18 is the flowchart in FIG. 17 in which step S105 has been replaced with steps S301 and S302.

Step S301 is performed when it is determined that the degree of recognition of the shape of the road by the driver is the threshold or more in step S202 (NO in step S202). The need to perform assistive irradiation in the prominent mode is low when the degree of recognition of the shape of the road by the driver is high, so that the assistive irradiation control unit 15 performs assistive irradiation in a first mode that is a less prominent mode (low visibility mode) in step S301. This suppresses assistive irradiation being an obstacle for the driver.

Step S302 is performed when it is determined that the degree of recognition of the shape of the road by the driver is less than the threshold in step S202 (YES in step S202). The need to perform assistive irradiation in the prominent mode is high when the degree of recognition of the shape of the road by the driver is low, so that the assistive irradiation control unit 15 performs assistive irradiation in a second mode that is a more prominent mode in step S302. This effectively improves the degree of recognition of the shape of the road by the driver.

Considered are a case where the size of the irradiation pattern in assistive irradiation in the second mode is larger than the size of the irradiation pattern in assistive irradiation in the first mode and a case where the color tone of the irradiation pattern in assistive irradiation in the second mode is lighter than the color tone of the irradiation pattern in assistive irradiation in the second mode, for example.

According to the driving assistance apparatus 10 according to Embodiment 3, proper assistive irradiation according to the degree of recognition of the shape of the road by the driver can be performed.

### Modifications

While an example in which the assistive irradiation control unit 15 switches between two types of assistive irradiation according to the degree of recognition of the shape of the road by the driver has been shown in Embodiment 3, two or more thresholds of the degree of recognition may be set to break down the degree of recognition, and the assistive irradiation control unit 15 may switch among three or more types of assistive irradiation according to the degree of recognition. Alternatively, the assistive irradiation control unit 15 may change the mode of assistive irradiation continuously or in multiple stages according to the degree of recognition.

For example, assistive irradiation in a mode having the animation effect may be performed when the degree of recognition of the shape of the road by the driver is low. A speed and an amount of a change in animation may be increased with decreasing degree of recognition.

When the mode of assistive irradiation is continuously changed, the size of the irradiation pattern may continuously be changed, or the amount of the change in animation may continuously be changed, for example.

### Examples of Hardware Configuration

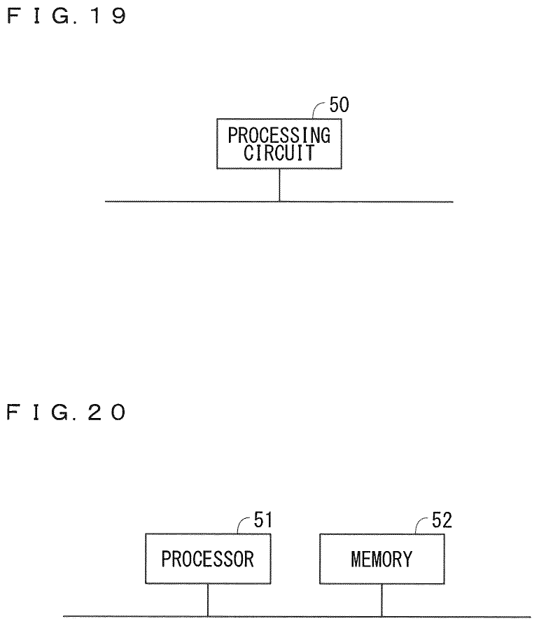

FIGS. 19 and 20 are diagrams showing examples of a hardware configuration of each driving assistance apparatus 10. Each of the functions of the components of the driving assistance apparatus 10 shown in FIG. 1 is implemented by a processing circuit 50 shown in FIG. 19, for example. That is to say, the driving assistance apparatus 10 includes the processing circuit 50 to acquire information on the shape of the road on which the host vehicle 100 is traveling, acquire information on whether the road has the side wall, judge whether brightness around the host vehicle 100 is brightness requiring assistive irradiation being irradiation with light encouraging the driver of the host vehicle 100 to recognize the shape of the road, determine whether assistive irradiation is performed based on the presence or absence of the side wall of the road, the shape of the road, and a result of judgment on the brightness around the host vehicle 100, and control the lighting apparatus 20 of the host vehicle 100 to perform assistive irradiation when it is determined that the assistive irradiation is performed. The processing circuit 50 determines that assistive irradiation is performed when the road has the side wall, the road is curved horizontally or vertically, and it is judged that the brightness around the host vehicle 100 is brightness requiring assistive irradiation and irradiates the side wall of the road with at least part of the light to perform assistive irradiation.

The processing circuit 50 may be dedicated hardware or may be configured using a processor (also referred to as a central processing unit (CPU), a processing unit, an arithmetic unit, a microprocessor, a microcomputer, and a digital signal processor (DSP)) to execute a program stored in memory.

When the processing circuit 50 is the dedicated hardware, the processing circuit 50 corresponds to a single circuit, a composite circuit, a programmed processor, a parallel programmed processor, an application specific integrated circuit (ASIC), a field programmable gate array (FPGA), or a combination thereof, for example. The functions of the components of the driving assistance apparatus 10 may be implemented by discrete processing circuits or may collectively be implemented by a single processing circuit.

FIG. 20 shows an example of a hardware configuration of the driving assistance apparatus 10 in a case where the processing circuit 50 is configured using a processor 51 to execute the program. In this case, the functions of the components of the driving assistance apparatus 10 are implemented by software and the like (software, firmware, or software and firmware). The software and the like are described as the program and are stored in memory 52. The processor 51 reads and executes the program stored in the memory 52 to implement the functions of the components. That is to say, the driving assistance apparatus 10 includes the memory 52 to store the program which, when executed by the processor 51, results in performance of processing of acquiring the information on the shape of the road on which the host vehicle 100 is traveling; acquiring the information on whether the road has the side wall, judging whether brightness around the host vehicle 100 is brightness requiring assistive irradiation being irradiation with light encouraging the driver of the host vehicle 100 to recognize the shape of the road, determining whether assistive irradiation is performed based on the presence or absence of the side wall of the road, the shape of the road, and a result of judgment on the brightness around the host vehicle 100, and controlling the lighting apparatus 20 of the host vehicle 100 to perform assistive irradiation when it is determined that assistive irradiation is performed. The processor 51 to execute the program determines that assistive irradiation is performed when the road has the side wall, the road is curved horizontally or vertically, and it is judged that brightness around the host vehicle 100 is brightness requiring assistive irradiation and irradiates the side wall of the road with at least part of the light to perform assistive irradiation. In other words, it can be said that this program is to cause a computer to execute procedures and methods of operation of the components of the driving assistance apparatus 10.

The memory 52 herein may be, for example, nonvolatile or volatile semiconductor memory, such as random access memory (RAM), read only memory (ROM), flash memory, erasable programmable read only memory (EPROM), and electrically erasable programmable read only memory (EEPROM), a hard disk drive (HDD), a magnetic disk, a flexible disk, an optical disc, a compact disc, a mini disc, a digital versatile disc (DVD), and a drive device thereof or any storage medium to be used in the future.

A configuration in which the functions of the components of the driving assistance apparatus 10 are implemented by the hardware or by the software and the like has been described above. The configuration, however, is not limited to this configuration, and one or more of the components of the driving assistance apparatus 10 may be implemented by the dedicated hardware, and the other one or more of the components may be implemented by the software and the like. For example, functions of the one or more of the components can be implemented by the processing circuit 50 as the dedicated hardware, and functions of the other one or more of the components can be implemented by the processing circuit 50 as the processor 51 reading and executing the program stored in the memory 52.

As described above, the driving assistance apparatus 10 can implement the above-mentioned functions by hardware, software and the like, or a combination thereof.

Embodiments can freely be combined with each other and can be modified or omitted as appropriate.

The foregoing description is in all aspects illustrative, and it is understood that numerous unillustrated modifications can be devised.

### EXPLANATION OF REFERENCE SIGNS

1 vehicle system, 10 driving assistance apparatus, 11 road shape information acquisition unit, 12 side wall information acquisition unit, 13 brightness judgement unit, 14 assistive irradiation determination unit, 15 assistive irradiation control unit, 16 recognition degree estimation unit, 20 lighting apparatus, 21 headlamp, 22 sublamp, 31 map database, 32 positioning apparatus, 33 surroundings detection apparatus, 34 image recognition apparatus, 50 processing circuit, 51 processor, 52 memory, 100 host vehicle, 101 headlamp light, 102 irradiation pattern, 201 straight side wall, 202 curved side wall.

1. A driving assistance apparatus comprising:
a processor to execute a program; and
a memory to store the program which, when executed by the processor, performs processes of:
acquiring information on a shape of a road on which a host vehicle is traveling;
acquiring information on whether the road has a side wall;
judging whether brightness around the host vehicle is brightness requiring assistive irradiation, the assistive irradiation being irradiation with light encouraging a driver of the host vehicle to recognize the shape of the road;
determining whether the assistive irradiation is performed based on the presence or absence of the side wall of the road, the shape of the road, and a result of judgment on the brightness around the host vehicle; and
controlling a lighting apparatus of the host vehicle to perform the assistive irradiation when it is determined that the assistive irradiation is performed, wherein
the processor determines that the assistive irradiation is performed when the road has the side wall, the road is curved horizontally or vertically, and it is judged that the brightness around the host vehicle is the brightness requiring the assistive irradiation, and
the processor irradiates the side wall of the road with at least part of the light to perform the assistive irradiation.

2. The driving assistance apparatus according to claim 1, wherein
the processor estimates a degree of recognition of the shape of the road by the driver, and
the processor determines that the assistive irradiation is not performed when the degree of recognition is less than a predetermined threshold.

3. The driving assistance apparatus according to claim 2, wherein the processor estimates the degree of recognition based on a difference in color tone between the side wall and a road surface of the road.

4. The driving assistance apparatus according to claim 2, wherein
the processor estimates the degree of recognition based on a visual ability of the driver.

5. The driving assistance apparatus according to claim 2, wherein
the processor estimates the degree of recognition based on a difference in color tone between markings and a road surface of the road.

6. The driving assistance apparatus according to claim 2, wherein
the processor estimates the degree of recognition based on whether the road has a road structure encouraging recognition of the shape of the road.

7. The driving assistance apparatus according to claim 1, wherein
the processor estimates a degree of recognition of the shape of the road by the driver, and
the processor performs the assistive irradiation in a more prominent mode when the degree of recognition is lower.

8. The driving assistance apparatus according to claim 7, wherein
the processor estimates the degree of recognition based on a difference in color tone between the side wall and a road surface of the road.

9. The driving assistance apparatus according to claim 7, wherein
the processor estimates the degree of recognition based on a visual ability of the driver.

10. The driving assistance apparatus according to claim 7, wherein
the processor estimates the degree of recognition based on a difference in color tone between markings and a road surface of the road.

11. The driving assistance apparatus according to claim 7, wherein
the processor estimates the degree of recognition based on whether the road has a road structure encouraging recognition of the shape of the road.

12. The driving assistance apparatus according to claim 1, wherein
the assistive irradiation is performed by irradiating the side wall or a road surface of the road with a dot irradiation pattern or a linear irradiation pattern.

13. The driving assistance apparatus according to claim 12, wherein
the side wall of the road is irradiated with the dot irradiation pattern, and the side wall of the road or each of the side wall and the road surface of the road is irradiated with the linear irradiation pattern.

14. The driving assistance apparatus according to claim 12, wherein
each of the irradiation patterns simulates a road structure encouraging recognition of the shape of the road.

15. The driving assistance apparatus according to claim 12, wherein
the processor changes a mode of the dot irradiation pattern with which the side wall of the road is irradiated over time.

16. The driving assistance apparatus according to claim 1, wherein
the processor changes a mode of the assistive irradiation according to the shape of the road.

17. The driving assistance apparatus according to claim 1, wherein
the processor changes a mode of the assistive irradiation according to a travel speed of the host vehicle.

18. A driving assistance method comprising:
acquiring information on a shape of a road on which a host vehicle is traveling;
acquiring information on whether the road has a side wall;
judging whether brightness around the host vehicle is brightness requiring assistive irradiation, the assistive irradiation being irradiation with light encouraging a driver of the host vehicle to recognize the shape of the road;
determining whether the assistive irradiation is performed based on the presence or absence of the side wall of the road, the shape of the road, and a result of judgment on the brightness around the host vehicle; and
controlling a lighting apparatus of the host vehicle to perform the assistive irradiation when it is determined that the assistive irradiation is performed, wherein
the assistive irradiation is determined to perform when the road has the side wall, the road is curved horizontally or vertically, and it is judged that the brightness around the host vehicle is the brightness requiring the assistive irradiation, and
the side wall of the road is irradiated with at least part of the light to perform the assistive irradiation.
